(19) United States
(12) Patent Application Publication
(10) Pub. No.: US 2006/0165310 A1
(43) Pub. Date: Jul. 27, 2006

(54) Method and apparatus for a virtual scene previewing system

(76) Inventor: Newton Eliot Mack, Somerville, MA (US)

Correspondence Address: George S. Haight IV;Brown Rudnick Berlack Israels, LLP, One Financial Center, Boston, MA, 02111, US

(21) Appl. No.: 11/260,810

(22) Filed: Oct. 27, 2005

Related U.S. Application Data
(60) Provisional application No. 60/622,352, filed on Oct. 27, 2004.

(51) Int. Cl. G06K 9/36; G06K 9/32

(52) U.S. Cl. 382/284; 382/294

(57) ABSTRACT

A virtual scene previewing system is provided. A scene camera records the image of a subject in front of a background. The scene camera is connected to a computer by a data cable. A tracking camera is positioned above the scene camera and is also connected to a computer by a data cable. The scene camera has a marker attached to it that can be seen by the tracking camera. The tracking camera records the location of the tracking marker on the scene camera. The tracking camera will process the movement of the scene camera by recording its location through the tracking marker. The images provided by the computer are then adjusted accordingly. Additional tracking cameras may be added to the configuration to create an overlapping network of tracking cameras and creating a larger set space with which a director or camera operator may operate.

### CROSS REFERENCE TO RELATED APPLICATIONS

This application claims the benefit under 35 U.S.C. §119(e) of co-pending U.S. Provisional application Ser. No. 60/622,352 filed on Oct. 27, 2004, which is incorporated by reference herein.

### FIELD OF INVENTION

The present invention relates to image production, more specifically, to the production of a virtual scene previewing system.

### BACKGROUND OF THE INVENTION

Virtual Set technology has been used in broadcasting and graphic design applications for years. Feature films, television shows and video games utilize a virtual world to visually enhance the viewers' experience. For example, one of the most common and well-known applications of virtual set technology is a weather broadcast on a local or national news network. To a viewer at home, the scene portrays a broadcaster standing next to or in front of a screen with an image on it, typically a map or satellite photo. This is a virtual set. In reality the broadcaster is standing in front of what is generally referred to as a “Blue Screen”. The blue screen, usually a retro-reflective material, is blank to anyone looking directly at it in the studio. The image of the weather map or satellite photo is generated and superimposed by a computer onto the imagery that is transmitted across the television airwaves using a process known in the art as traveling matte. The broadcaster uses a television off to the side of the set to reference his movements or gestures against the map. The map is added in a real-time algorithm that alters the image from the live camera into the composite image that is seen on television.

Virtual set technology has expanded greatly in recent years leading to entire television programs and countless numbers of feature film scenes being filmed with the aid of composite images superimposed into the recorded video. The use of computer generated imagery (“CGI”) has allowed film makers and directors to expand the normal conventions of scenery and background imagery in their productions. Powerful computers with extensive graphics processors generate vivid, high-definition images that cannot be recreated by hand, or duplicated by paint. The use of CGI reduces the number of background sets needed to film a production. Rather than have several painted or constructed background scenes, computer generated images can serve as backdrops reducing the space and cost required to build traditional sets.

In the arena of video games, movies, and television, virtual set technology is used to create backgrounds, model, and record character movement. The recorded movements are then overlaid with computer graphics to makes the video game representation of the movement more true to life. In the past, to create character movement for a video game, complex mathematical algorithms were created to model the movement of the character. Because the character movement model was never completely accurate, the character's movement appeared choppy and awkward. With the advent of virtual set technology, a “library” of movements can be recorded live and superimposed onto the characters in post-production processing. Video games with unique characters and unique character movements, such as football or baseball simulation games, benefit from such technology. The technology makes the game appear much more realistic to the player.

The increased capability of employing virtual set technology, however, does come with the added cost of powerful and complex graphics processors, or engines, as well as specialized equipment and background screens. On a set in which the cameras are moving, the computers must track the location of the camera at all times in relation to the screen to properly create a realistic scene. Many existing systems require the use of a special background with embedded markers that enable the computer to calculate the camera's position in the virtual scene by using a marker detection method. Other existing systems utilize a second camera, called a tracking camera affixed to the first camera, or scene camera. The tracking camera references the location of tracking markers fixed to the ceiling to calculate the location of the camera in the scene. Because the tracking camera is mounted to the scene camera, both move together through the set and can be located along a coordinate grid. This configuration requires the tracking computer to constantly process large numbers of markers to calculate and reference the scene cameras locations. Such heavy processing slows down the computers and transmission of the composite final image. In a live broadcast, these delays create performance problems and a “seamless” combination of live video and imagery is not always achieved.

### SUMMARY OF THE INVENTION

Virtual scene previewing systems expand the capabilities of producing video. Virtual scene systems allow a producer to import three-dimensional texture mapped models and high resolution two-dimensional digital photographs and mix them with live video. Use of modern techniques from the world of visual effects like camera projection mapping and matte painting provide for even more flexibility in the creation of a video production.

Various embodiments of a virtual scene previewing system are provided. In one embodiment, a scene camera records the image of a subject in front of a background. The scene camera is connected to a computer by a data cable. A tracking camera is positioned above the scene camera and is also connected to a computer, either the same computer or another computer on a network, by a data cable. The scene camera has a marker attached to it that can be seen by the tracking camera. The tracking camera records the location of the tracking marker on the scene camera. If the scene camera moves during recording, the tracking camera will process its location by the tracking marker and the images provided by the computer can be adjusted accordingly. Additional tracking cameras may be added to the configuration to create an overlapping network of tracking cameras and creating a larger set space with which a director or camera operator may operate.

In one embodiment of the inventive method, a scene camera records an image. The image or images are then transmitted to a computer. A second camera, the tracking camera, captures an image of a marker. The marker is affixed to the scene camera in this embodiment. The images of the tracking marker are also sent to a computer. The computer, using a three-dimensional graphics engine, will superimpose a computer-generated image or images into the live recording image from the camera. The graphics engine processes the location of the tracking marker in combination with the data of the computer generated image to adjust for factors such as proper depth, field of view, position, resolution, and orientation. The adjusted virtual images or background are combined with the live recording to form a composite layered scene of live action and computer generated graphics.

In yet another embodiment, a retro-reflective background is added to the scene. The background is located opposite the scene camera with the object to be viewed placed in between the background and camera. The first camera views a scene and transmits the imagery to the computer. The tracking camera remains stationary and can track the scene camera, with the affixed marker, so long as the scene camera remains in the field of view of the tracking camera. Multiple tracking cameras can be implemented to create an overlapping field of view. The computer resolves the location of the scene camera in the overlapped areas through common image processing methods. The computer generates a real-time virtual scene image combining the imagery of the scene camera with a stored background image to create a virtual set. The location data from the tracking camera(s) is used to adjust the virtual real-time scene to create a seamless virtual environment.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 depicts a perspective view of a studio with a scene camera positioned to photograph a subject in front of a background in accordance with an embodiment of the present invention;

FIG. 2 depicts a perspective view of a studio with a scene camera and more than one tracking camera in accordance with an embodiment of the present invention;

FIG. 3 depicts a block diagram of an embodiment of the present invention describing the data flow between parts of the system;

FIG. 4A depicts a subject layer of a composite image seen from a scene camera in one embodiment of the present invention;

FIG. 4B depicts a background layer of a composite image stored on the computer as virtual objects in accordance with an embodiment of the present invention; and

FIG. 4C depicts a composite proxy image, combining the subject and background layers in accordance with one embodiment of the present invention.

### DETAILED DESCRIPTION

The present invention provides a cost effective, reliable system for producing a virtual scene combining live video enhanced by computer generated imagery. The present invention provides a seamless environment expanding the capabilities of virtual video production. Applications ranging from video games to feature films can implement the system for a fraction of the cost of traditional virtual sets. The system greatly reduces the costly and complex computer processing time required in existing systems. The present invention also eliminates the need for specialized materials used in the backgrounds of virtual sets.

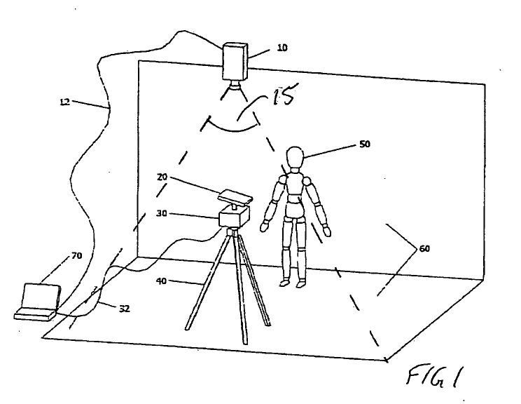

An embodiment of the present invention is illustrated in FIG. 1. A scene camera 30 is positioned to capture an image of a subject 50 in front of a background 60. The scene camera 30 is mounted on a camera support 40. This camera support 40 may be in the form of a tripod, dolly, handheld, stabilized, or any other form of camera support in common use. There may be more than one scene camera in order to capture different views of the subject's performance. The scene camera 30 is connected to a computer 70 by a scene camera data cable 32. A tracking camera 10 is positioned over the scene camera 30 and oriented so that a tracking marker 20 is within its field of view 15. The computer 70 may be positioned near the scene camera 30 so that the camera operator can see the system output.

The tracking marker 20 in one embodiment is a flat panel with a printed pattern on its top. The tracking marker 20, of this embodiment is advantageous as it requires no power cables, thus the scene camera 30 can easily be adapted for any type of use including handheld, stabilized or other forms of camera shots where extra cables would hamper the scene camera's 30 motion. The tracking camera 10 is connected to the computer 70 by a tracking camera data cable 12. The tracking camera 10 and scene camera 30 may also be connected to separate computers 70 that communicate with each other through a network.

Although the present embodiment depicted describes a data cable as the means of connecting the cameras to the processors, one skilled in the art should recognize that any form of data transmission can be implemented without deviating from the scope of the invention.

The tracking camera 10 is used to collect images of the tracking marker 10. The image quality required for tracking the tracking marker 10 is lower than the image quality generally required for the scene camera 30, enabling the use of a lower cost tracking camera 10. In one embodiment, the tracking camera 10 is a simple electronic camera with a fixed field of view 75. Since the tracking camera 10 is not focused upon the scene, the tracking performance is independent of the exact contents and lighting of the subjects 50 in the scene. This independence extends to the background 60. As mentioned before, existing systems require the use of a special background to enable the scene camera's position to be derived from the images it produces. The present implementation of a separate tracking camera 10, as shown in the present embodiment, eliminates the need for special background materials and complex set preparation.

In some existing systems, the tracking camera is mounted on the scene camera and moves with it, while several tracking markers are mounted on the ceiling. This requires the tracking computer to process large numbers of markers, which can cause delays in the performance of the tracking algorithms. Mounting the tracking marker 20 to the scene camera 30 and keeping the tracking camera 10 stationary greatly simplifies processing. The present embodiment requires the computer 70 to search only for one type of tracking marker 20, thus increasing tracking speed. The computer 70 is not overwhelmed with myriad tracking markers that add to the cost and complexity of the processing method.

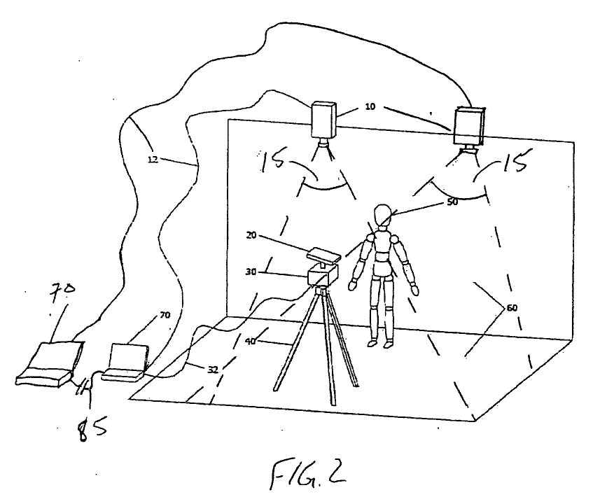

In the embodiment depicted in FIG. 2, multiple overlapping tracking cameras 10 are utilized. A scene camera 30 is positioned to capture an image of a subject 50 in front of a background 60. The scene camera is mounted on a camera support 40. This camera support 40 may be in the form of a tripod, dolly, handheld, stabilized, or any other form of camera support in common use. There may be more than one scene camera in order to capture different views of the subject's performance. The scene camera 30 is connected to a computer 70 by a scene camera data cable 32. The tracking cameras 10 are positioned over the scene camera 30. Each tracking camera 10 is connected to a separate computer 70, in this embodiment, to perform tracking calculations. The computers 70 may be connected via a network 85. When a tracking marker 20 can be seen by two tracking cameras 10 in multiple fields of view 15 simultaneously, the multiple sets of coordinates of the tracking marker 20 must be resolved due to calibration differences between the tracking cameras 10. This can be achieved by several methods, including but not limited to, averaging, preferential ranking of one tracking camera's 10 coordinates over another's, or Kalman type filtering. With simple averaging, the resulting position can be expressed as:

$$rPos = Resulting Position$$

$${cPos}_{1 , n} = {Camera}_{1 , n} Position$$

$$rPos = \frac{( {\sum }_{1}^{n} {cPos}_{n} )}{n}$$

A preferential weighted average can be computed over several readings (represented below as numStoredValues) with a weighting factor filterWeight, (0<filterWeight<1), as:

```
float currentWeight = 1.0f;
float filterWeight = 0.7f;
float average = 0;
float averageTotal = 0;
int numStoredValues = 5;
float storedValues[5];
for (int i = 0; i < numStoredValues; i++)
{
    average += storedValues[i] * currentWeight;
    averageTotal += 1.0f * currentWeight;
    currentWeight *= filterWeight;
}
rPos = average / averageTotal;
```

This filter causes more recent values (placed in storedValues[0]) to be given more weight, and provides a smoothing effect on the data to prevent the camera position from jumping, disturbing the illusion of a seamless image. Before each run, the values in the storedValues array are shifted one over, discarding the oldest value and placing the newest value in storedValues[0]. With two or more cameras supplying coordinates, the coordinates from the various cameras would simply be averaged together before being added to the most recent storedValues[0].

The tracking marker 20 in this embodiment is a flat panel with a printed pattern on its top. The tracking marker 20 of this embodiment is advantageous as it requires no power cables, thus the scene camera 30 can easily be adapted for any type of use including handheld, stabilized or other forms of camera shots where extra cables would hamper the scene camera's 30 motion. The tracking camera 10 is connected to the computer 70 by a tracking camera data cable 12. The tracking camera 10 and scene camera 30 may also be connected to a single computer 70 that is capable of processing both tracking cameras 10 images.

In addition to studio use, the present invention can be used at a physical set or location; this is advantageous if the background 60 were to be composed of a combination of physical objects and computer generated objects.

Although the present embodiments depicted illustrate the use of one scene camera 30, one skilled in the art should recognize that any number of scene cameras to accommodate multiple views, and multiple viewpoints can be implemented without deviating from the scope of the invention.

Further, while the present embodiments depicted show the use of one or two tracking cameras, one skilled in the art should recognize that any number of tracking cameras may be implemented to increase the movement range of the scene camera without deviating from the scope of the invention.

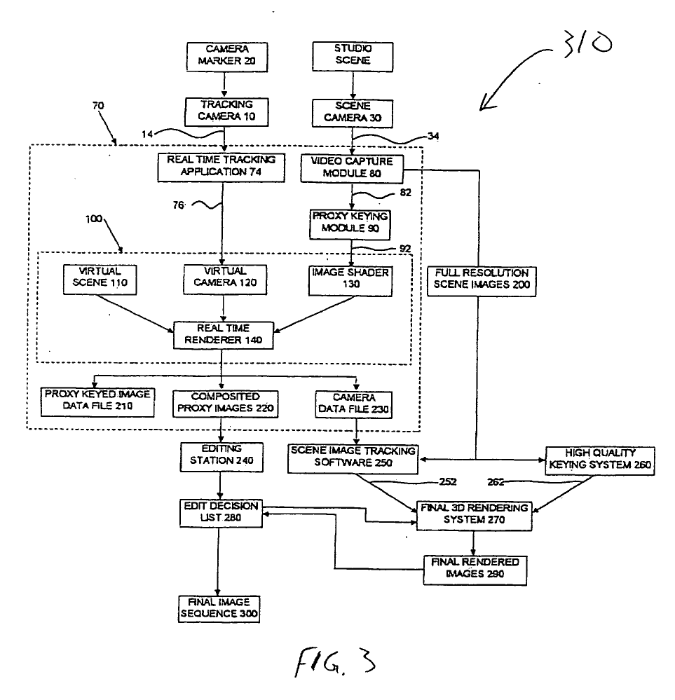

Turning now to FIG. 3, the data flow 310 during operation of the system is shown in accordance with an embodiment of the present invention. The tracking camera 10 is focused on the tracking marker 20 and sends tracking image data 14 to a real-time tracking application 74 running on computer 70. The tracking image data 14 can be simply represented by a buffer containing red, green, and blue data for each pixel; an industry standard is to create image buffers with 8 bytes of data for each red pixel, followed by eight bytes for green and eight bytes for blue. Each component running on computer 70 may optionally be run on a separate computer to improve computation speed. In one embodiment all of the components run on the same computer 70. A real-time tracking application 74 processes the tracking image data 14 to generate proxy camera coordinate data 76 for a virtual camera 120 operating within a real-time three-dimensional engine 100.

The proxy camera coordinate data consists of camera position and orientation data transmitted as a string of floating point numbers in the form (posX posY posZ rotx rotY rotZ). The scene camera 30 sends record image data 34 of the subject 50's performance to a video capture module 80 running on the computer 70. This video capture module 80 generates proxy image data 82 which is sent to a proxy keying module 90. The proxy image data 82 is generated in the standard computer graphics format of a RGB buffer, typically containing but not limited to twenty-four bytes for each pixel of red, green, and blue data (typically eight bytes each.) The proxy image data 82 includes not only visual information of the scene's contents, but also information describing the precise instant the image was captured. This is a standard data form known in the art as timecode. This timecode information is passed forward through the system along with the visual information. The timecode is used later to link the proxy images to full resolution scene images 200, also generated by the scene camera 30, as well as final rendered images 290.

The proxy keying module 90 generates proxy keyed image data 92 which is then sent to an image plane shader 130 operating within the real-time three-dimensional engine 100. The real-time three-dimensional engine 100 also contains a virtual scene 110 which contains the information needed to create the background image for the composite scene. The real-time three-dimensional engine 100 is of a type well known in the industry and used to generate two-dimensional representations of three-dimensional scenes at a high rate of speed. This technology is commonly found in video game and content creation software applications. While the term “real-time” is commonly used to describe three-dimensional engines capable of generating two-dimensional representations of complex three-dimensional scenes at least twenty-four frames per second, the term as used herein is not limited to this interpretation.

The real-time tracking application 74 processes the tracking image data 14 to generate the proxy camera coordinate data 76 using a set of algorithms implemented in the ARToolkit software library, an image processing library commonly used in the scientific community. The software library returns a set of coordinates of the target pattern in a 3×4 transformation matrix called patt₁₃trans. The positional and rotational data is extracted from the 3×4 patt_trans matrix with the following statements, which convert the data in the patt_trans matrix into the more useful posX, posY, posZ, rotX, rotY, and rotZ components. An example of source code to perform this conversion is shown in Appendix A.

The use of standard references, or fiducial markers, as tracking markers 20 has many advantages. Since the markers are of a known size and shape, and as the tracking camera 10 can be a standardized model, the calibration of the tracking camera 10 to the tracking marker 20 can be calculated very accurately and standardized at the factory. This enables the use of the system in the field on a variety of scene cameras 30 and support platforms without needing to recalibrate the system. The two components that do the measuring work only need to be calibrated once before delivery. The fiducial marker calibration data can be calculated using standard routines available in the ARToolkit library. The tracking camera calibration data can likewise be generated using these standard routines, and included in a file with the rest of the system. Since the calibration data is based on the focal length and inherent distortions in the lens, the calibration data does change over time.

The real-time three-dimensional engine 100 uses the proxy camera coordinates 76 to position the virtual camera 120 and the image shader 130 within the virtual scene 110. The image shader 130, containing the proxy keyed image data 92, is applied to planar geometry 132. The planar geometry 132 is contained within the real-time three-dimensional engine 100 along with the virtual scene 110. The planar geometry 132 is typically located directly in front of the virtual camera 120 and perpendicular to the orientation of the virtual camera's 120 lens axis. This is done so that the virtual scene 110 and the proxy keyed image data 92 line up properly, and give an accurate representation of the completed scene. The code sample, provided in Appendix A provides the proper conversions to generate the position and orientation format needed by the engine: centimeters for X, Y, and Z positions, and degrees for X, Y, and Z rotations. When the scene camera 30 is moved, the virtual camera 120 inside the real-time three dimensional engine 100 sees both the virtual scene 120 and the proxy keyed image data 92 in matched position and orientations, and produces composited proxy images 220.

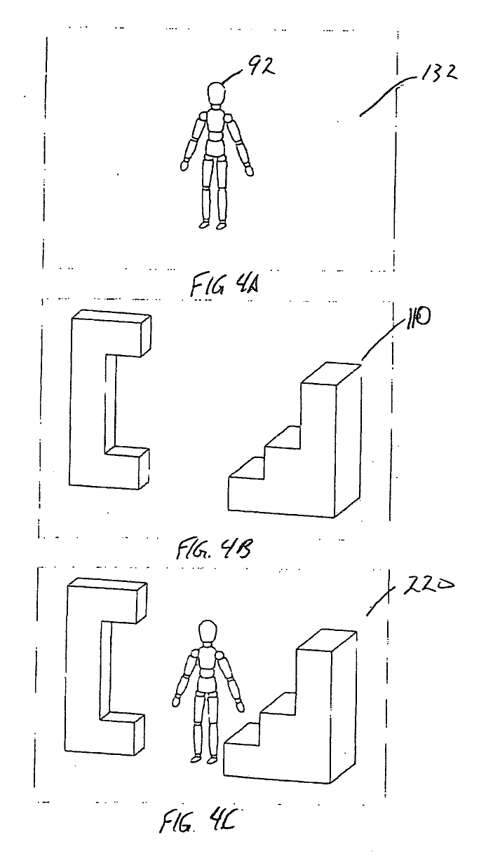

The image combination, according to one embodiment is shown in FIGS. 4A, 4B, and 4C. The planar geometry 132 may be located at an adjustable distance from the virtual camera 120; this distance may be manually or automatically adjustable. This allows the proxy keyed image data 92 to appear in front of or behind objects in the virtual scene 110 for increased image composition flexibility. As the planar geometry 132 moves closer to the virtual camera 120, its size must be decreased to prevent the proxy keyed image data 92 from being displayed at an inaccurate size. This size adjustment may be manual or automatic. In the present embodiment this adjustment is automatically calculated based upon the field of view of the virtual camera 120 and the distance from the planar geometry 132 to the virtual camera 120.

The design of the real-time three-dimensional engines 100 is well established within the art and has been long used for video games and other systems requiring a high degree of interactivity. In one embodiment, the real-time three-dimensional engine is used to generate the composited proxy images 220. As an additional embodiment, the real-time three-dimensional engine 100 may also produce the final rendered images 290 given the proper graphics processing and computer speed to narrow or eliminate the quality difference between real-time processing and non real-time processing.

The proxy image sequence may also be displayed as it is created to enable the director and the director of photography to make artistic decisions of the scene camera 30 and the subject 50's placement within the scene. In one embodiment, the proxy image sequence is displayed near the scene camera 30, allowing the camera operator to see how the scene will appear as the scene camera 30 is moved.

In addition to composited proxy image sequence 220, the real-time three-dimensional engine 100 also produces a camera data file 230 and a proxy keyed image data file 210. These files collect the information from the proxy camera coordinate data 76 and the proxy keyed image data 92 for a single take of the subject's 50 performance. These may be saved for later use. In an embodiment of the present invention, a second virtual camera can be created within the virtual scene 110 that moves independently from the original virtual camera 120. The original virtual camera 120 moves according to the proxy camera coordinate data 76, and the planar geometry 132 containing the proxy keyed image data 92 moves with the original virtual camera 120. In this manner, a second virtual camera move, slightly different from the original virtual camera 120 move, can be generated. If the second camera moves very far away from the axis of the original virtual camera 120, the proxy keyed image data 92 will appear distorted as it will be viewed from an angle instead of perpendicular to the plane it is displayed on. A second virtual camera, however, can be used to create a number of dramatic camera motions. The final versions of the camera data and scene image data can also be used to create this effect.

To create a final composite set image, the precise scene camera 30 location and orientation data must be known. A camera data file 230, as it is the collected data set of the proxy camera coordinate data 76, will generally not be sufficiently accurate for final versions of the composite image. It can be used, however, as a starting point for the scene tracking software 250. The scene image tracking software 250 uses the full resolution scene images 200 to calculate the precise scene camera 30 location and orientation for each take of the subject's 50 performance, using inter-frame variation in the images. This type of software is well known and commercially available in the visual effects industry; examples include Boujou by 2d3, Ltd., of Lake Forest, Calif. and MatchMover by Realviz, S.A, of San Francisco, Calif. The level of accuracy of this type of software is very high, but requires significant computer processing time per frame and as such is not useful for the real-time calculation of the proxy camera coordinate data 76. The scene image tracking software 250 is used to generate final camera coordinate data 252 which is then imported into a final three-dimensional rendering system 270. This three-dimensional rendering system 270 generates the final high quality versions of the background scene. The background information is very similar to that found in virtual scene 110 but with increased levels of detail necessary to achieve higher degrees of realism.

In one embodiment of the present system, the final camera coordinate data 252 drives a motion control camera taking pictures of a physical set or a miniature model; this photography generates the final background image which is then composited together with final keyed scene data 262.

The full resolution scene images 200 are also generated from the scene camera 30 using a video capture module 80. This can be the same module used to generate the proxy scene image data 82 or a separate module optimized for high quality image capture. This can also take the form of videotape, film, or digitally based storage of the original scene images. The present embodiment uses the same video capture module 80.

The full resolution scene images 200 are then used by both the scene image tracker software 250 and the high quality keying system 260. The scene image tracker software 250, as previously mentioned, generates the final camera coordinate data 252 by implementing the image processing applications, mentioned above, on the scene image. The high quality keying system 260 creates the final keyed scene images 262 through a variety of methods known in the industry, including various forms of keying or rotoscoping. These final keyed scene images can then be used by the final three dimensional rendering system 270 to generate final rendered images 290. Alternatively, the final keyed scene images can be combined with the final rendered images 290 using a variety of compositing tools and methods well known within the industry. Common industry tools include Apple Shake, Discreet Combustion, and Adobe After Effects; any of these tools contain the required image compositing mathematics. The most common mathematical transform for combining two images is the OVER transform; this is represented by the following equation, where Colorₐ is the foreground value of the R, G, and B channels, and Color_{b} is the background value of the same. Alphaₐ is the value of the alpha channel of the foreground image; this is used to control the blending between the two images.
Colorₒᵤₜₚᵤₜ=Colorₐ+Color_{b} ×(1−Alphaₐ)

The composite proxy images 220 may then brought into an editing station 240 for use by editors, who select which performance or take of the subject 50 they wish to use for the final product. The set of decisions of which take to be used, and the location and number of images within that take needed for the final product, are then saved in a data form known in the industry as an edit decision list 280. The composited proxy image 220 is linked to the matching full resolution scene image 200 using the previously mentioned timecode, which adds data to each image describing the exact moment that it was captured. The edit decision list 280 is initially used by the final three-dimensional rendering system 270 to select which background frames to be rendered, as this is an extremely computationally expensive process and needs to be minimized whenever possible. The edit decision list 280, however, will change throughout the course of the project, so industry practice is to render several frames both before and after the actual frames requested in a take by the edit decision list. The final rendered images 290 can then be assembled into a final output sequence 300 using the updated edit decision list 280 without having to recreate the final rendered images 290.

In addition to the description of specific, non-limited examples of embodiments of the invention provided herein, it should be appreciated that the invention can be implemented in numerous other applications involving the different configurations of video-processing equipment. Although the invention is described hereinbefore with respect to illustrative embodiments thereof, it will be appreciated that the foregoing and various other changes, omissions and additions in the form and detail thereof may be made without departing from the spirit and scope of the invention.

```
APPENDIX A
double sinPitch, cosPitch, sinRoll, cosRoll, sinYaw, cosYaw;
double EPSILON = .00000000001;
float PI = 3.14159;
sinPitch = −patt_trans[2][0];
cosPitch = sqrt(1 − sinPitch*sinPitch);
if ( abs(cosPitch) > EPSILON )
{
    sinRoll = patt_trans[2][1] / cosPitch;
    cosRoll = patt_trans[2][2] / cosPitch;
    sinYaw = patt_trans[1][0] / cosPitch;
    cosYaw = patt_trans[0][0] / cosPitch;
}
else
{
    sinRoll = −patt_trans[1][2];
    cosRoll = patt_trans[1][1];
    sinYaw = 0;
    cosYaw = 1;
}
// Rotation data
float tempRot = atan2(sinYaw, cosYaw) * 180/PI;
camRaw.rotY = −(180 − abs(tempRot))* tempRot/abs(tempRot));
tempRot = atan2(sinRoll, cosRoll) * 180 / PI;
camRaw.rotX = (180 − abs(tempRot))* (tempRot/abs(tempRot));
camRaw.rotZ = atan2(sinPitch, cosPitch) * 180 / PI;
// Position data
camRaw.posX = patt_trans[1][3];
camRaw.posY = −patt_trans[2][3];
camRaw.posZ = patt_trans[0][3];
```

What is claimed is:

1. An image producing system comprising:
a first camera viewing a first image within a defined space, the first camera including a visual marker;
a tracking camera, positioned to obtain a view of the visual marker for the first camera, the tracking camera capturing coordinate position information of the visual marker within the defined space; and
a processor in communication with the first camera and the tracking camera, the processor receiving time codes from the first camera and the coordinate position information from the tracking camera; to allow for generating a composite image comprising the first image and a second image, the second image being adjusted to simulate a camera view for the second image based on the coordinate position information of the marker of the first camera.

2. The image producing system of claim 1, further comprising a background, the processor superimposing the second image over the background in the composite image, the background comprising one of a retro-reflective background or a uniform-color background.

3. The image producing system of claim 1 wherein the coordinate position information of the visual marker of the first camera comprises orientation information of the visual marker.

4. The image producing system of claim 1, further comprising a plurality of stationary tracking cameras, wherein the coordinate position information of the visual marker of the first camera is determined by resolving the coordinate position information of the visual marker captured by the plurality of tracking cameras.

5. The image producing system of claim 4, wherein a Kalman filter is used to resolve the coordinate position information of the visual marker of the first camera.

6. The image producing system of claim 4, wherein the coordinate position information of the visual marker of the first camera is resolved by a preferential ranking of the plurality of tracking cameras.

7. A method of generating a virtual scene comprising:
capturing a first image with a first camera, the first camera including a visual marker;
capturing a second image of the visual marker using a tracking camera to determine the coordinate position information of the first camera;
receiving time codes from the first camera and the coordinate position information from the tracking camera; and
generating a composite image comprising the first image and a third image, the third image being adjusted to simulate a camera view for the third image based on the coordinate position information of the visual marker of the first camera.

8. The method of claim 7, further comprising tracking in real-time the coordinate position information of the visual marker of the first camera.

9. The method of claim 7, further comprising receiving orientation information of the visual marker from the tracking camera.

10. The method of claim 7, wherein the step of capturing a first image further comprises capturing the first image in front of a background, the background comprising one of a retro-reflective background or a uniform-color background.

11. The method of claim 7, wherein the step of generating a composite image, the third image is a background image.

12. The method of claim 7, wherein the step of capturing a second image further comprises capturing at least two images of the visual marker from a plurality of stationary tracking cameras and determining the coordinate position information of the visual marker by resolving the coordinate position information of the visual marker captured by the plurality of tracking cameras.

13. The method of claim 12, further comprising resolving the coordinate position information of the marker using a Kalman filter.

14. The method of claim 12, further comprising resolving the coordinate position information of the marker using a predefined preferential ranking of the plurality of tracking cameras.

15. An image producing system comprising:
a scene camera producing a first image of a scene, the first camera having a marker;
a stationary tracking camera having a field of view, the marker of the first camera disposed within the field of view of the second camera, the second camera viewing a location of the marker of the first camera;
a retroreflective background, the scene disposed between the background and the scene camera; and
a processor generating a real-time virtual scene image determined by the location of the marker of the first camera, the first image, and the stored image in the memory.

16. The image producing system of claim 15, wherein the processor further comprises a three-dimensional real-time graphics engine.

17. The image producing system of claim 15, further comprising a plurality of stationary tracking cameras having a plurality of fields of view, the location of the marker of the first camera determined by resolving the location of the marker captured by the plurality of tracking cameras.

18. The image producing system of claim 17, wherein a Kalman filter is used to resolve the location of marker of the first camera.

19. The image producing system of claim 17, wherein the location of the marker of the first camera is resolved by a preferential ranking of the plurality of tracking cameras.

20. The image producing system of claim 15, wherein the processor comprises a plurality of processors interconnected on a network.
